(19) United States
(12) Patent Application Publication
(10) Pub. No.: US 2009/0277016 A1
(43) Pub. Date: Nov. 12, 2009

(54) Utility knife with an auto-retractable blade

(76) Inventor: Yuewei Wu, Ninghai (CN)

Correspondence Address: Jackey Hong, 3979 Amberley Lane, Marietta, GA, 30062, US

(21) Appl. No.: 12/149,692

(22) Filed: May 7, 2008

(51) Int. Cl. B26B 1/08; B26B 5/00

(52) U.S. Cl. 30/162; 30/335

(57) ABSTRACT

A utility knife with an auto-retractable blade, having a housing containing a blade therein. An actuator is provide being fixed to a slider contained in the housing and slidable with respect to the housing. The slider, having an upper hook and a lower hook and being able to coact with an upper protrusion and a lower protrusion of a blade seat also contained in the housing, are able to automatically retract into the housing after the blade leaves a workpiece and before a user of the knife releases the actuator for extending the blade. The blade will not undesirably move backward in cutting.

### BACKGROUND OF THE INVENTION

1. Field of the Invention

The invention relates to a utility knife with an auto-retractable blade contained in a housing of the utility knife, and more particularly, to the utility knife the blade thereof is able to automatically retract into the housing after the blade leaves a workpiece and before a user of the knife releases an actuator for extending the blade.

2. Description of the Prior Art

Utility knife is a commonly used hand tool for cutting, e.g., wood, paper, leather, plastic panel, cord, and cardboard. It often has a housing made up of two covers detachably coupling together. The housing acts as both a handle and a container for a blade slidably received therein. An actuator is provided in an aperture defined in the handle for moving the blade.

In order to avoid hurting persons after cutting, some utility knives having auto retractable blade are provided. A blade of the utility knife is able to retract back into the housing when a user release the actuator after cutting. However, dangers still exist when a user, who is abstracted or not agile enough to release the actuator, waves the utility knife to himself or other with his finger pressing on the actuator and the blade extending after leaving a workpiece.

A cutting device with a retractable blade in which the blade automatically retracts into the handle before a clumsy user can bring it toward himself or toward anyone else after a cutting edge of the blade leaves a workpiece is disclosed in U.S. Pat. No. 6,775,911. The cutting device successfully lowers the aforementioned dangers but still has some drawbacks. First, in a process of cutting, sometimes there are backward forces acting on the blade along an axis of the blade in a direction from the extended blade to the handle. The backward forces may come into being, e.g., when the user involuntarily moves the handle towards the workpiece in the cutting. However at some other times, a friction between the blade and the cut workpiece may pull the blade to move out from the handle when the user move the handle backward in cutting. Since when extended, the blade is fixed with respect to the handle by the friction between two elements, the intermediate portion (20) and the intermediate portion (40, 42) of the branches (30a, 30b), the backward force may become greater than the element friction, and the blade may undesirably move backward. On the other hand, when the workpiece friction becomes greater than the element friction, the blade may undesirably move forward. It is not stable enough in cutting.

Second, the controllable movement (26) mounted on the sleeve (10) is complex in structure and the whole coact between the controllable movement (26) and the support means (16) depends on a modulus of elasticity and a friction factor of the surfaces thereof. An unsuitable combination of the modulus of elasticity and the friction factor of the controllable movement (26) and the support means (16) may cause the blade either overly easy or too hard to move with respect to the handle. The complexity in structure and fixation of a proper modulus of elasticity and friction factor altogether increase a cost of manufacturing.

Third, the cubic shape of the controllable movement (26) has a relative greater width, which makes the volume and the weight of the knife be larger than necessary.

### BRIEF SUMMARY OF THE INVENTION

The main object of the invention is to provide a utility knife a blade of which is able to automatically retract into a housing after the blade leaves a workpiece and before a user of the knife releases an actuator for extending the blade, and which is able to block the undesirable forward or backward movement of the blade.

Another object of the invention is to provide a utility knife with an auto-retractable blade which is simple in structure.

object of the invention is to provide a utility knife with an auto-retractable blade which has a thinner width.

In accordance with one aspect of the invention, there is provided a utility knife having a housing; a blade slidably received in the housing, the blade having a notch for installation; an actuator reciprocally slidable along the housing for controlling the blade to extend; a slider contained in the housing and fixed to the actuator and slidable with respect to the housing, the slider having an upper hook and a lower hook; a slider return spring one end thereof is fixed to the slider and the other end thereof is fixed to an inner surface of the housing; a blade seat in the housing for installation of the blade, the blade seat having an upper protrusion, a lower protrusion, a blade installation plate, an upper fulcrum, and a lower fulcrum, the blade installation plate having a rear end fixed to the blade seat with a pivot and a front end having a side finger and a blade installation pillar which engages with the notch of the blade; a blade seat return spring having a front end fixed to the blade seat and a rear end fixed to the housing in such a deployment that the rear end is higher than the front end; and, a blade change means contained in a channel defined in the housing and reciprocally movable with respect thereto, the blade change means having a top end and a slope defined on the housing.

These and other objectives, features, and advantages of the present invention will become apparent from the following detailed description, the accompanying drawings, and the appended claims.

### BRIEF DESCRIPTION OF THE DRAWINGS

FIG. 1 is a perspective schematic view of the preferred embodiment of the utility knife of the invention.

FIG. 2 is an exploded perspective view showing the utility knife shown in FIG. 1.

FIGS. 3 to 6 are partially exploded perspective views showing an operation of the embodiment shown in FIG. 1.

FIG. 7a to 7f are schematic perspective views showing working of a blade change means.

FIGS. 8a and 8b are schematic perspective views showing working of a blade installation plate. And,

FIG. 9 is a partially exploded view of the utility knife shown in FIG. 1.

### DETAILED DESCRIPTION OF THE PREFERRED EMBODIMENT

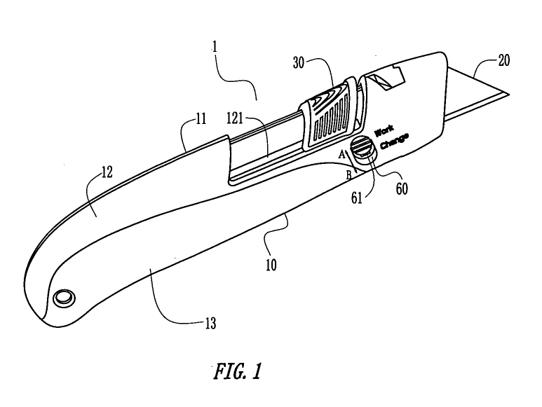

With reference to FIGS. 1 and 2, a utility knife 1 with an auto-retractable blade of the preferred embodiment of the invention is shown. The utility knife 1 has a housing 10 made up of a first upper cover 11, a second upper cover 12 and a lower cover 13 detachably coupling together, a blade 20 slidably received in the housing 10, an actuator 30 reciprocally slidable along the housing 10 for controlling the blade 20 to extend, a slider 40 contained in the housing 10 beside an inner surface of the first upper cover 11 and being fixed to the actuator 30 and slidable with respect to the housing 10, a slider return spring 41 one end thereof is fixed to the slider 40 and the other end thereof is fixed to the inner surface of the housing 10, a blade seat 50 in the housing 10 between the slider 40 and the second upper cover 12 for installation of the blade 20, a blade seat return spring 54, and a blade change means 60. The housing 10 acts as both a container for the blade 20 and a handle.

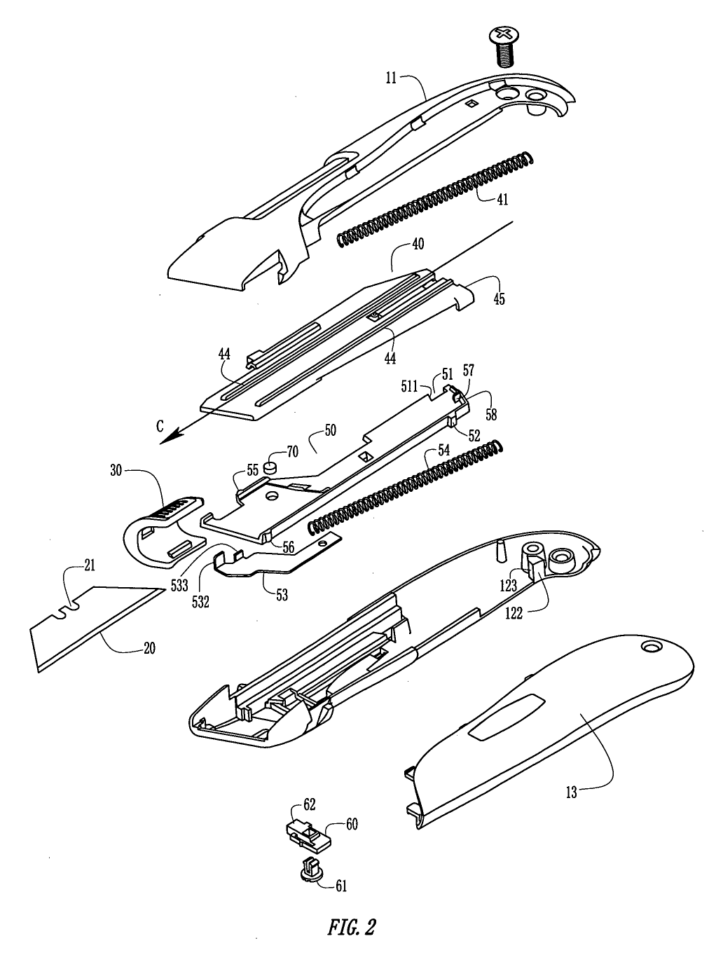

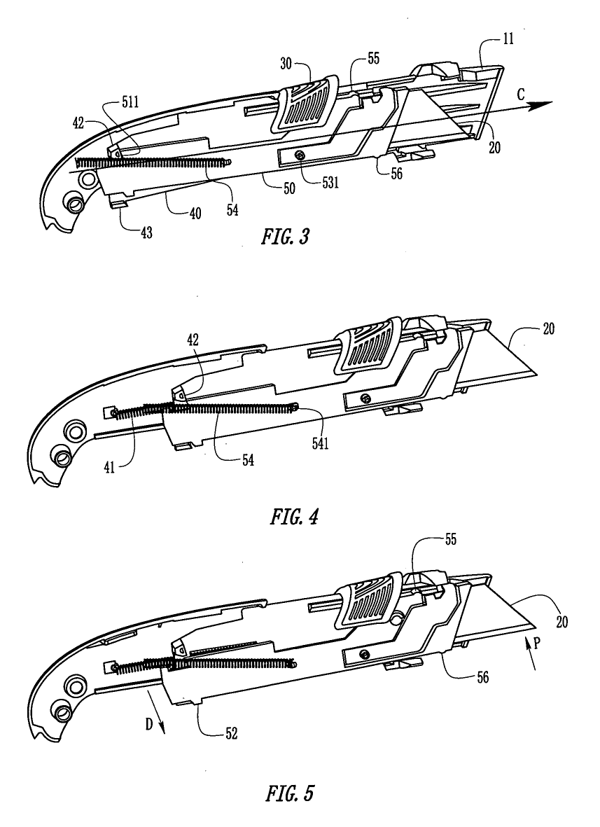

As particularly shown in FIG. 2, the housing 10 has an axis C along which the blade 20 is able to slide. The slider 40 is fixed to the actuator 30 and when the actuator 30 is pushed forward, the slider 40 moves forward accordingly. The slider return spring 41 is basically parallel to the axis C and able to pull back the slider 40 when a user release the actuator 30. The slider 40 has an upper hook 42 (as particularly shown in FIGS. 3 and 4) and a lower hook 43. It may have one or more ribs 44 which are able to engage into corresponding guiding slits (not shown in the FIGs.) defined in the inner surface of the first upper cover 11 to ensure a stable sliding of the slider 40 with respect to the first upper cover 11.

The blade seat 50 is able to slide with respect to the housing 10 basically along the axis C. The blade seat 50 has an upper recess 51, a lower protrusion 52, a rear blocker 57, a blade installation plate 53, an upper fulcrum 55, and a lower fulcrum 56. The blade installation plate 53 has a rear end which is fixed to the blade seat 50 with a pivot 531 and a front end having a side finger 532 and a blade installation pillar 533 which is able to engage with a notch 21 of the blade 20 in installation. The blade installation plate 53 is made of hard material having a certain elasticity such as steel. Especially with reference to FIG. 5, a front end 541 of the blade seat return spring 54 is fixed to the blade seat 50 and a rear end 542 thereof is fixed to the housing 10 in such a deployment that the rear end 542 is higher than the front end 541. Back to FIGS. 2 and 3, the upper recess 51 has an upright face 511.

With reference to FIG. 3, an operation of the utility knife 1 will be described in detail. In a spare status as shown in the FIG., the actuator 30, and the slider 40 fixed thereto, is pulled to and stays at a rear most position by the slider return spring 41. The upper hook 42 of the slider 40 meets and is blocked by the upright face 511 of the upper recess 51 of the blade seat 50. Comes to FIG. 4, a work status of the utility knife 1 is shown. The actuator 30 is pushed forward by a thumb of the user to an work position. The slider 40, which is fixed to the actuator 30, moves forward accordingly against the slider return spring 41. When the slider 40 moves, the upper hook 42 thereof drives the upright face 511 of the upper recess 51, thus the blade seat 50, to move forward at the same time against the blade seat return spring 54.

Further with reference to FIG. 5, when the user cuts a workpiece (not shown in the FIG.) with the blade 20 extended, a knifepoint portion of the blade 20 gets a upright force P, which may force the blade 20 and the blade seat 50 to rotates about the upper fulcrum 55 of the blade seat 50. As the blade seat 50 rotates, the upright face 511 of the upper recess 51 of the blade seat 50, moving in direction D as shown, leaves the upper hook 42 of the slider 40, and the lower protrusion 52 of the blade seat 50 meets and is blocked by the lower hook 43 of the slider 40. As long as the actuator 30 is pushed by the user to stay at the work position, a backward movement of the blade seat 50, thus the blade 20 fixedly installed thereon, will be stopped by the lower hook 43 of the slider 40. At the same time, a rear end 45 of the slider 40 meets and is stopped by the rear blocker 57 of the blade seat 50. The blade seat 50, thus the blade 20 installed thereon, will not be able to move forward with respect to the slider 40, thus the actuator 30 in cutting. Thus, the blade 20 may not undesirably move forward or backward and become stable in cutting. Since the blade seat return spring 54 is not parallel to the axis C of the housing 10 but is inclined with the rear end 542 being higher than the front end 541 thereof, the rotation of the blade seat 50 will be against the blade seat return spring 54, and generate an upright resuming force from the blade seat return spring 54.

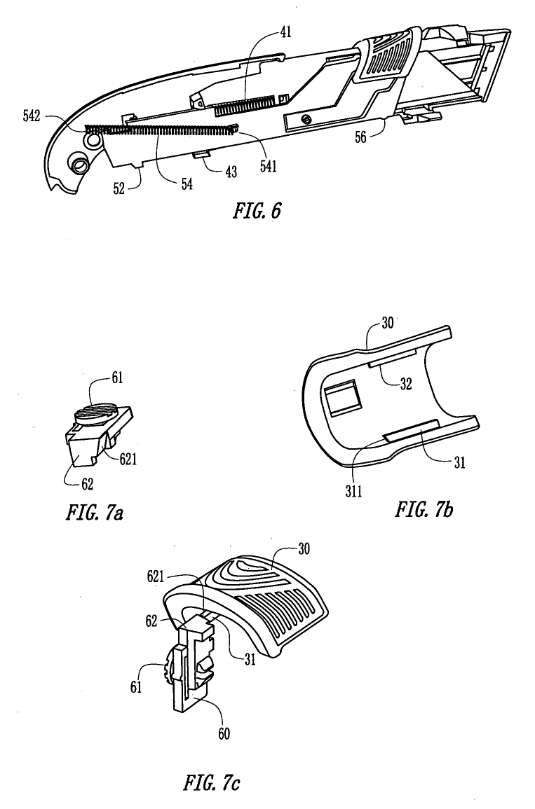

As shown in FIG. 6, as soon as the blade 20 leaves the workpiece after cutting, force P disappears. The blade seat 50 rotates about the upper fulcrum 55 thereof under the upright resuming force of the blade seat return spring 54 contrary to the direction D shown in FIG. 5. In the rotation, the lower protrusion 52 of the blade seat 50 will leave the lower hook 43 of the slider 40. Once the lower protrusion 52 leaves the lower hook 43, the blade seat 50 will be pulled to move backward by the blade seat return spring 54 to a spare status as shown. Thus, it could be seen that the blade 20 of the utility knife 1 of the invention is able to automatically retract into the housing 10 after the blade 20 leaves the workpiece and before the user intentionally releases the actuator 30 to retract the blade 20.

After the blade seat 50 stops at the spare position, the user may release the actuator 30. The actuator 30 and the slider 40 will then be pulled to move backward by the slider return spring 41. In the movement, the upper hook 42 of the slider 40 goes along the blade seat 50 towards the upper recess 51. As the upper hook 42 moves along the blade seat 50, the blade seat 50 will be pushed by the upper hook 42 to rotate about the lower fulcrum 56 thereof against the blade seat return spring 54. After the upper hook 42 passes the upright face 511 of the upper recess 51, the blade seat 50 reversely rotates about the upper fulcrum 55 under a resuming force of the blade seat return spring 54. The utility knife 1 of the invention thus resumes the spare status as shown in FIG. 3 and is able to be used for the next time. Back to FIG. 2, a magnet 70 may be fixedly installed on the blade seat 50 on a surface facing the blade 20. The magnet 70 is able to make the blade 20, which is ferrous, stabler with respect to the blade seat 50.

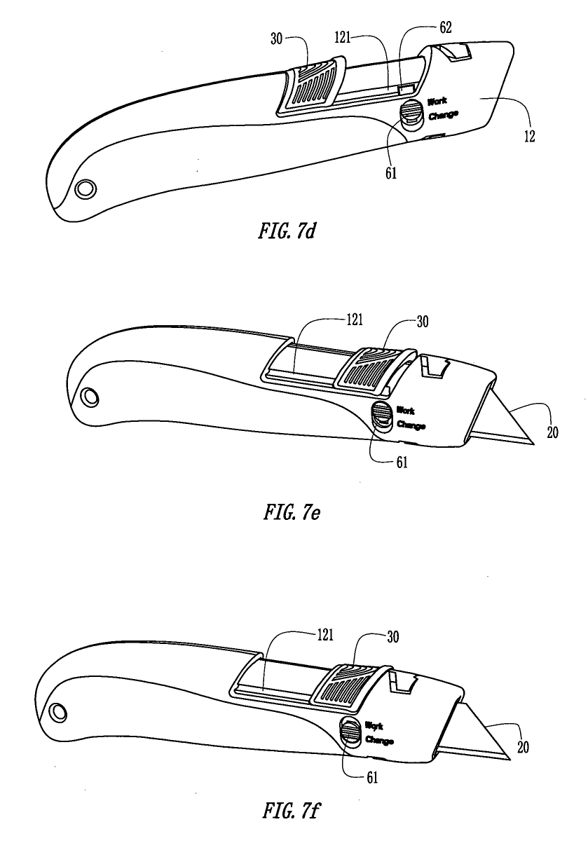

With reference to FIGS. 7a to 7e, a working of the blade change means 60 will be described hereinafter in detail. The blade change means 60 is contained in a channel defined in the housing 10 and reciprocally movable with respect thereto in directions A and B as shown in FIG. 1. The blade change means 60 has a top end 62 and a button 61 formed thereon facilitating pushing with a thumb of a user. As shown in FIG. 7b, the actuator 30 has a sliding side bar 31 formed on an inner surface thereof. The sliding side bar 31 is able to engage in a slit 121 defined in the second upper cover 12 along the axis C to ensure the reciprocally slidable movement of the actuator 30 with respect to the housing 10. The actuator 30 may also has an auxiliary sliding side bar 32 formed on an opposite inner surface thereof. The auxiliary sliding side bar 32 engages in a corresponding slit (not shown) defined in the first upper cover 11 along the axis C to ensure a stabler sliding movement of the actuator 30.

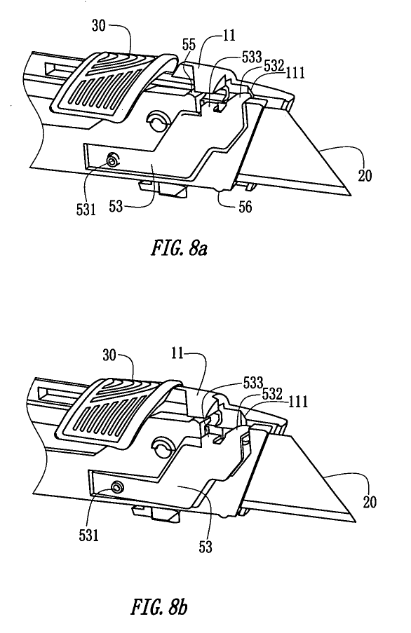

With reference to FIG. 7d, the user is able to push the button 61 upward in the direction A to a work position in which the top end 62 thereof moves upward accordingly across the slit 121. At this work position of the blade change means 60, when the user pushes the actuator 30 forwardly, the sliding side bar 31 will meet the top end 62 of the blade change means 60 and stopped thereby, as shown in FIG. 7e. As particularly shown in FIG. 8a, at this work position of the button 61, the side finger 532 of the blade installation plate 53 just meets a slope 111 defined on the first upper cover 11 and the blade installation pillar 533 engages in the notch 21 of the blade 20. The blade 20 is not able to be pulled out for replacement.

As shown in FIG. 7f, when the user pushes the button 61 downward in the direction B to a change position in which the top end 62 thereof moves downward accordingly out from the slit 121, he will be able to push the actuator 30 to a front most position. In the process of the pushing of the actuator 30 to the front most position, as particularly shown in FIG. 8b, the side finger 532 of the blade installation plate 53, which has a certain elasticity, will go along the slope 111 of the first upper cover 11 and thus push the front end of the blade installation plate 53 to deflect away from the blade seat 50 and the blade 20. When the actuator 30 is pushed to the front most position, the deflection of the front end of the blade installation plate 53 will be just able to make the blade installation pillar 533 leave and disengage with the notch 21 of the blade 20. The blade 20 is then able to be pulled out from the blade seat 50 and replaced. After the replacement, the user is able to release the actuator 30 and then push the button 61 back to the work position for the next use.

As shown in FIGS. 7a to 7c, a first coupling bevel 621 and a corresponding second coupling bevel 311 may be defined respectively on the top end 62 facing the actuator 30 and the sliding side bar 31 facing the blade change means 60. The second coupling bevel 311 faces the inner surface of the actuator 30. If the user pushes the actuator 30 forward until the first and the second coupling bevels 621 and 311 meet and keeps pushing, the first coupling bevel 621 will be able to exert a pressure on the second coupling bevel 311 in a direction opposite to the second coupling bevel 311. The pressure is able to prevent the actuator 30, which is usually made of plastic and has a certain elasticity, from falling off from the housing 10 if two sides of the actuator 30 move apart under the continuing forward pushing force of the user.

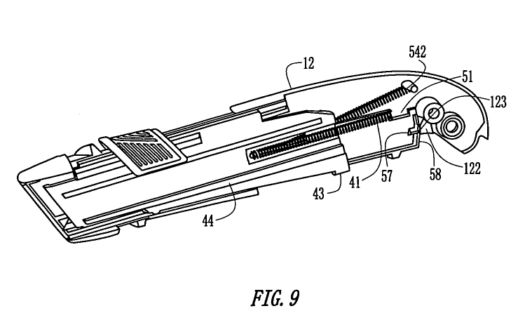

With reference to FIGS. 2 and 9, a limitation 122 may be formed on the second upper cover 12. When the blade seat 50 is pulled to move backward by the blade seat return spring 54, a rear end 58 of the blade seat 50 will eventually meet the limitation 122 and the blade seat 50 will then stop at the spare position. As aforementioned, when the user release the actuator 30, the slider 40 moves backward. After the upper hook 42 passes the upright face 511 of the upper recess 51, the blade seat 50 reversely rotates about the upper fulcrum 55 under the resuming force of the blade seat return spring 54. A friction between the rear end 58 of the blade seat 50 and the limitation 122 may prevent the rotation under the resuming force of the blade seat return spring 54. As shown in the FIGs., to minimize the friction, the rear end 58 may be defined to be oblique. A corresponding oblique surface 123 may be defined on the limitation 122 facing the rear end 58.

It could be seen from above description, that with the slider 40 having the upper hook 42 and the lower hook 43, which is able to coact with the upper recess 51 and the lower protrusion 52, the utility knife 1 of the invention is able to realize the function of auto-retracting the blade 20 after cutting with a simple structure. And, a plate like shape of the slider 40 is able to make a width of the utility knife 1 small.

What is claimed is:

1. A utility knife comprising:
a housing;
a blade slidably received in said housing, said blade having a notch for installation;
an actuator reciprocally slidable along said housing for controlling said blade to extend;
a slider contained in said housing and fixed to said actuator and slidable with respect to said housing, said slider having an upper hook and a lower hook;
a slider return spring one end thereof is fixed to said slider and the other end thereof is fixed to an inner surface of said housing;
a blade seat in said housing for installation of said blade, said blade seat having an upper recess, a lower protrusion, a blade installation plate, an upper fulcrum, and a lower fulcrum, said blade installation plate having a rear end fixed to said blade seat and a front end having a side finger and a blade installation pillar which engages with said notch of said blade;
a blade seat return spring having a front end fixed to said blade seat and a rear end fixed to said housing in such a deployment that said rear end is higher than said front end; and,
a blade change means contained in a channel defined in said housing and reciprocally movable with respect thereto, said blade change means having a top end, a button formed thereon, and a slope defined on said housing.

2. The utility knife as claimed in claim 1, wherein said housing is made up of a first upper cover, a second upper cover and a lower cover detachably coupling together.

3. The utility knife as claimed in claim 1, wherein said slider has at least one rib which engages into at least one corresponding guiding slit defined in said inner surface of said housing.

4. The utility knife as claimed in claim 2, wherein said slider has at least one rib which engages into at least one corresponding guiding slit defined in said inner surface of said housing.

5. The utility knife as claimed in claim 1, wherein said actuator has a sliding side bar formed on an inner surface thereof.

6. The utility knife as claimed in claim 4, wherein said actuator has a sliding side bar formed on an inner surface thereof.

7. The utility knife as claimed in claim 5, wherein said actuator has an auxiliary sliding side bar formed on an inner surface thereof opposite to said sliding bar, said auxiliary sliding side bar engaging in a corresponding slit defined in said housing.

8. The utility knife as claimed in claim 6, wherein said actuator has an auxiliary sliding side bar formed on an inner surface thereof opposite to said sliding bar, said auxiliary sliding side bar engaging in a corresponding slit defined in said housing.

9. The utility knife as claimed in claim 6, wherein a first coupling bevel and a corresponding second coupling bevel are defined respectively on said top end facing said actuator and said sliding side bar said facing said blade change means, with second coupling bevel facing said inner surface of said actuator.

10. The utility knife as claimed in claim 8, wherein a first coupling bevel and a corresponding second coupling bevel are defined respectively on said top end facing said actuator and said sliding side bar said facing said blade change means, with second coupling bevel facing said inner surface of said actuator.

11. The utility knife as claimed in claim 1, wherein a magnet is fixedly installed on said blade seat on a surface facing said blade.

12. The utility knife as claimed in claim 4, wherein a magnet is fixedly installed on said blade seat on a surface facing said blade.

13. The utility knife as claimed in claim 6, wherein a magnet is fixedly installed on said blade seat on a surface facing said blade.

14. The utility knife as claimed in claim 10, wherein a magnet is fixedly installed on said blade seat on a surface facing said blade.

15. The utility knife as claimed in claim 1, wherein a limitation is formed on said housing.

16. The utility knife as claimed in claim 4, wherein a limitation is formed on said housing.

17. The utility knife as claimed in claim 6, wherein a limitation is formed on said housing.

18. The utility knife as claimed in claim 10, wherein a limitation is formed on said housing.

19. The utility knife as claimed in claim 14, wherein a limitation is formed on said housing.

20. The utility knife as claimed in claim 19, wherein a rear end of said blade seat is oblique and a corresponding oblique surface is defined on said limitation facing said rear end.
